(19) United States
(12) Patent Application Publication
(10) Pub. No.: US 2024/0384073 A1
(43) Pub. Date: Nov. 21, 2024

(54) RUBBER COMPOSITION COMPRISING A PARTIALLY BIOSOURCED PLASTICIZER

(71) Applicant: TOTALENERGIES ONETECH, Courbevoie (FR)

(72) Inventors: Francine GENIN, Houilles (FR); Benjamin SWOBODA, Orgeval (FR); Franco CATALDO, Rome (IT)

(21) Appl. No.: 18/691,389

(22) PCT Filed: Sep. 12, 2022
(86) PCT No.: PCT/EP2022/075227

§ 371 Date: Mar. 12, 2024

(30) Foreign Application Priority Data
Sep. 14, 2021 (EP) 21306261.5

(51) Int. Cl. C08L 9/06; B60C 1/00; C08J 3/18; C08K 3/04; C08K 3/36; C08L 91/00

(52) U.S. Cl. CPC C08L 9/06; B60C 1/0016; C08J 3/18; C08K 3/04; C08K 3/36; C08L 91/00; C08J 2309/06; C08L 2205/02

(57) ABSTRACT

The present invention relates to a rubber composition for tire applications comprising:
at least one rubber polymer, and
at least one plasticizer comprising at least one vegetable oil and at least one petroleum-based oil selected from T-DAE products, MES products, naphthenic oils, and mixtures thereof.

### TECHNICAL FIELD

The present invention relates to new plasticizers partially produced from raw materials from renewable sources and applied in formulations of cross-linkable or cross-linked rubber compositions usable in tires, and applied to tires treads in particular.

### BACKGROUND ART

Petroleum-based plasticizers are currently used in rubber compounding for tire applications, among which DAE (Distillate Aromatic Extract), MES (Mild Extract Solvate), TDAE (Treated Distillate Aromatic Extract) products, RAE (Residual Aromatic Extract), and naphthenic oils.

Nowadays, industrials try to reduce the content of petroleum-based products. However, reducing the content of petroleum-based products should not lead to a fundamental loss of performances. EP 3251872 A1 discloses a rubber composition comprising a diene-based elastomer, a fatty acid monoester, a petroleum-derived oil and silica.

WO2011/130525 discloses a rubber composition comprising a rubber compound and a processing oil, wherein the processing oil comprises a modified tall oil pitch.

In this context, there is a need for rubber compositions for tire application in general and tire tread application in particular, comprising effective plasticizers having a reduced content of petroleum-based oils that are easily available and with satisfying performances. There is indeed a need for rubber compositions for tire application wherein the traditional petroleum-based plasticizers like the treated distillate aromatic extract (T-DAE) and the mild (or medium) extract solvate (MES) are partially replaced, even at high loading, by an efficient product from renewable source.

### SUMMARY OF THE INVENTION

The present invention relates to a rubber composition for tire applications comprising:
At least one rubber polymer, and
at least one plasticizer comprising at least one vegetable oil and at least one petroleum-based oil selected from T-DAE products, MES products, naphthenic oils, and mixtures thereof.

According to an embodiment, the rubber polymer is selected from optionally functionalized styrene-butadiene rubber (SBR), polybutadiene rubber (BR), natural rubber (NR), polyisoprene rubber (IR), ethylene-propylene-diene monomer rubber (EPDM), polybutadiene (PB), nitrile butadiene rubber (NBR), polychloroprene rubber, butyl rubber, silicone rubber, and mixtures thereof.

According to an embodiment, the rubber composition of the invention comprises two rubber polymers, wherein the rubber polymers comprise:
from 20 to 90% by weight of styrene-butadiene rubber(s) optionally functionalized and
from 10 to 80% by weight of at least one rubber selected from polybutadiene rubber (BR), natural rubber (NR), polyisoprene rubber (IR) and mixtures thereof, based on the total weight of the rubber polymers.

According to an embodiment of the invention, the vegetable oil is selected from tall oil, pitch tall oil, optionally epoxidized soybean oil, and mixtures thereof, more preferably from pitch tall oil, epoxidized soybean oil and mixtures thereof, even more preferably from pitch tall oil.

According to an embodiment of the invention, the petroleum-based oil is T-DAE and the vegetable oil is pitch tall oil. According to another embodiment of the invention, the petroleum-based oil is MES and the vegetable oil is an epoxidized soybean oil.

According to an embodiment of the invention, the plasticizer comprises:
from 50 to 99% by weight, preferably from 60 to 90% by weight, of petroleum-based oil(s), and
from 1 to 50% by weight, preferably from 10 to 40% by weight, of vegetable oil(s), based on the total weight of the plasticizer.

According to an embodiment of the invention, the rubber composition comprises from 5 to 80 PHR, preferably from 20 to 60 PHR, more preferably from 30 to 44 PHR of the plasticizer.

According to an embodiment of the invention, the rubber composition further comprises:
from 5 to 50 PHR, preferably from 10 to 40 PHR, more preferably from 20 to 30 PHR of carbon black, preferably of carbon black selected from grade N375, grade N220, grade N234 or grade N134 carbon black or mixtures thereof, and
from 10 to 90 PHR, preferably from 40 to 80 PHR, more preferably from 50 to 75 PHR of silica.

The present invention is also directed to the use of a composition comprising at least one petroleum-derived oil selected from T-DAE products, MES products, naphthenic oils and mixtures thereof, and at least one vegetable oil to plasticize rubber polymers.

According to an embodiment of the use of the invention, the composition is used to plasticize a mixture of at least two rubber polymers wherein the rubber polymers comprise from 20 to 90% wt of optionally functionalized styrene-butadiene rubber(s) (SBR) and from 10 to 80% of at least one rubber selected from polybutadiene rubber (BR), natural rubber (NR), polyisoprene rubber (IR) and mixtures thereof, based on the total weight of the rubber polymers.

According to an embodiment of the use of the invention, the vegetable oil is selected from tall oil, pitch tall oil, optionally epoxidized soybean oil, and mixtures thereof, more preferably from pitch tall oil, epoxidized soybean oil and mixtures thereof, even more preferably from pitch tall oil.

According to an embodiment of the use of the invention, (i) the petroleum-based oil is T-DAE and the vegetable oil is pitch tall oil or (ii) the petroleum-based oil is MES and the vegetable oil is an epoxidized soybean oil.

The present invention is also directed to a tire tread comprising the rubber composition according to the invention.

The present invention is also directed to a tire comprising a tire tread according to the invention.

The plasticizer of the invention comprising a petroleum-based oil and a vegetable-based oil provides satisfying properties for its use in rubber compositions.

The invention provides a partially biosourced plasticizer, that is easily available and that provides similar performances or even better performances than the petroleum-based oil alone, in particular for winter performances, dry traction and/or rolling resistance.

### DEFINITIONS

PHR, Parts per Hundred of Rubber polymer: unit used to quantify the amount of various ingredients present in a rubber composition, designating the number of parts by weight of each ingredient per hundred parts of rubber.

### DETAILED DESCRIPTION OF THE INVENTION

The present invention pertains to rubber compositions for tire applications comprising rubber polymers and a plasticizer composition comprising a petroleum-based oil and a vegetable oil.

### Petroleum-Based Oil

The petroleum-based oil used in the invention can be an aromatic oil. Generally, the aromatic oils have a content of aromatic compounds of between 30% and 95% by weight, advantageously of between 50% and 95% by weight, more advantageously of between 60% and 95% by weight, relative to the total weight of the aromatic oil. More preferentially, the aromatic oils have a content of saturated compounds of between 1% and 20% by weight, advantageously of between 3% and 15% by weight, more advantageously of between 5% and 10% by weight. More preferentially, the aromatic oils have a content of resin-based compounds of between 1% and 10% by weight, advantageously of between 3% and 5% by weight.

The contents of saturated, resin-based and aromatic compounds mentioned in the present patent application can be determined by Clay-Gel Absorption Chromatographic Method according to ASTM D2007.

More preferentially, the aromatic oils have a kinematic viscosity at 100° C. of between 0.1 and 150 mm2/s, advantageously of between 5 and 120 mm²/s, more advantageously of between 7 and 90 mm²/s (ASTM D 445 method).

More preferentially, the aromatic oils have a Cleveland flash point of greater than or equal to 150° C., advantageously of between 150° C. and 600° C., more advantageously of between 200° C. and 400° C. (EN ISO 2592 method).

More preferentially, the aromatic oils have an aniline point of between 20° C. and 120° C., advantageously of between 40° C. and 120° C. (ASTM D611 method).

More preferentially, the aromatic oils have a density at 15° C. of between 400 kg/m³ and 1500 kg/m³, advantageously of between 600 kg/m³ and 1200 kg/m³, more advantageously of between 800 kg/m³ and 1000 kg/m³ (ASTM D4052 method).

According to this advantageous embodiment, the aromatic oil comprises aromatic extracts of petroleum residues, obtained by extraction or dearomatization of residues from distillations of petroleum cuts.

The aromatic extracts are byproducts of the process for the refining of crude oils, obtained in particular from products of the vacuum distillation of atmospheric residues. They result from a simple or from a double extraction of the raffinate upgradable in lubricants, by means of a polar solvent. The different extracts are classified in different categories as a function of their process of production and are as follows:
DAE (Distillate Aromatic Extract) products,
MES (Mild Extract Solvate) products,
TDAE (Treated Distillate Aromatic Extract) products,
RAE (Residual Aromatic Extract) products,
TRAE (Treated Residual Aromatic Extract) products.

For example, the aromatic oils which can be used according to the invention can be chosen from the following products sold by TotalEnergies under the names: Plaxolene TD346® and Plaxolene MS132®.

For example, Plaxolene TD346® is a TDAE (Treated Distillates Aromatic Extract) which exhibits:
a density at 15° C. of between 940 kg/m3 and 970 kg/m³ (ASTM D4052 method),
a (Cleveland) flash point of approximately 220° C. (EN ISO 2592 method),
a kinematic viscosity at 100° C. of between 16 and 23 mm²/s (ASTM D 445 method),
an aniline point of between 64 and 72° C. (ASTM D611 method).

For example, Plaxolene MS132® is an MES (Mild Extract Solvate) which exhibits:
a density at 15° C. of between 895 kg/m³ and 925 kg/m³ (ASTM D4052 method),
a (Cleveland) flash point of approximately 230° C. (EN ISO 2592 method),
a kinematic viscosity at 100° C. of between 13 and 17 mm²/s (ASTM D 445 method),
an aniline point of between 85 and 100° C. (ASTM D611 method).

According to an embodiment, the petroleum-based oil is a naphthenic oil.

The petroleum-based oil used in the invention is preferably selected from T-DAE products, MES products and mixtures thereof.

### Vegetable Oil

Typically, the vegetable oil is in the form of acids and/or esters and/or amides, preferably in the form of acids and/or esters. The vegetable oil can be selected from fatty acids having from 6 to 24 carbon atoms in the form of acids and/or esters. A fatty acid ester is the product of reaction between at least one fatty acid and at least one alcohol, this alcohol can be a linear or branched mono-alcohol comprising from 1 to 5 carbon atoms, or a polyol comprising from 2 to 5 hydroxyl groups preferably a glycol, and/or two glycerols. Monoesters, diesters and triesters of polyols can thus be obtained. Included in this definition are the vegetable oils themselves and their transesterification products.

According to an embodiment, the vegetable oil is selected from the acids, esters or amides of tall oil, pitch tall oil, rapeseed, sunflower, castor, peanut, linseed, copra, olive, palm, cotton, corn, tallow, lard, palm kernel, soybean, pumpkin, grape seed, argan, jojoba, sesame, walnut, hazelnut, china wood, rice, and mixture thereof.

According to a preferred embodiment, the vegetable oil is selected from the tall oil, pitch tall oil, optionally epoxidized soybean oil, and mixtures thereof, more preferably from the acids and/or esters of pitch tall oil, epoxidized soybean oil and mixtures thereof, even more preferably from the acids and/or esters of pitch tall oil.

Typically, pitch tall oil is the residue from the distillation of tall oil. It generally contains primarily high-boiling esters of fatty acids and rosin. It may also contain neutral materials, free fatty acids and rosin acids.

According to an embodiment, the pitch tall oil acids and/or esters have an acid number ranging from 50 to 200 mgKOH/g, preferably from 100 to 140 mgKOH/g. The acid number may be measured by ASTM 3242 standard

According to an embodiment, the pitch tall oil acids and/or esters have a viscosity at 60° C. ranging from 100 to 1000 mPa·s, preferably from 200 to 850 mPa·s. The viscosity can be measured by ASTM D 2196-99.

According to an embodiment, the epoxidized soybean oil has an oxirane content ranging from 1 to 15% wt, preferably from 2 to 12% wt, more preferably from 4 to 10% wt, based on the total weight of the epoxidized soybean oil.

According to an embodiment, the pitch tall oil acids and/or esters have a viscosity at 25° C. ranging from 100 to 1000 mPa·s, preferably from 200 to 850 mPa·s (ASTM D 2196-99).

Vegetable oils that can be used in the present invention are commercially available products.

### Plasticizer Useful for the Invention

According to a particular embodiment, the plasticizer useful for plasticizing a rubber composition of the invention comprises at least one vegetable oil and at least one petroleum-based oil selected from T-DAE products, MES products, naphthenic oils, and mixtures thereof.

According to an embodiment, the plasticizer comprises at least one petroleum-based oil selected from T-DAE products and MES products and at least one vegetable oil selected from epoxidized vegetable oils, such as epoxidized soybean oils, and pitch tall oil.

According to an embodiment, the weight ratio between the petroleum-based oil and the vegetable oil is higher than 1/3, preferably higher than 1/2, more preferably higher than 1/1.

According to an embodiment, the plasticizer comprises:
from 50 to 99% by weight, preferably from 60 to 90% by weight, of petroleum-based oil(s), and
from 1 to 50% by weight, preferably from 10 to 40% by weight, of vegetable oil(s),

based on the total weight of the plasticizer.

According to an embodiment of the plasticizer:
(i) the petroleum-based oil is T-DAE products and the vegetable oil is pitch tall oil, or
(ii) the petroleum-based oil is MES and the vegetable oil is an epoxidized soybean oil.

According to an embodiment, the plasticizer comprises, based on the total weight of the plasticizer:
(i) from 50 to 99% by weight, preferably from 60 to 90% by weight, of T-DAE products, and from 1 to 50% by weight, preferably from 10 to 40% by weight, of pitch tall oil, or
(ii) from 50 to 99% by weight, preferably from 60 to 90% by weight, of MES products, and from 1 to 50% by weight, preferably from 10 to 40% by weight, of epoxidized soybean oil.

The plasticizing composition defined in the present invention can be used to plasticize a rubber composition for tire applications comprising rubber polymers, wherein the rubber polymers preferably comprise:
from 20 to 90% by weight of styrene-butadiene rubber(s) optionally functionalized and
from 10 to 80% by weight of at least one rubber selected from polybutadiene rubber (BR), natural rubber (NR), polyisoprene rubber (IR) and mixtures thereof,

based on the total weight of the rubber polymers.

According to a particular embodiment, the plasticizers defined in the present invention are used to improve the viscoelastic properties of the rubber composition. In particular, the plasticizers defined in the present invention allow to affect the elastic modulus E′ (also named storage modulus) as well as the viscous modulus E″ (also named loss modulus) of rubber compositions for tire, consequently, the ratio between E″ and E′ (named tan delta) is also improved thanks to the plasticizer of the invention. In fact, in tire and moreover in tire tread application the determination of the dynamic properties of a rubber compound (i.e. the determination of E′, E″ and tan δ) in a wide temperature range (applying the time-temperature superposition principle, well known to the experts in the art) allows to predict the behavior of the said rubber compound in terms of winter performances, wet and dry traction and rolling resistance.

According to an embodiment, the rubber composition comprises from 10 to 90 PHR of silica, preferably from 40 to 80 PHR of silica, more preferably from 50 to 75 PHR of silica.

According to an embodiment, the rubber composition comprises from 5 to 50 PHR, preferably from 10 to 40 PHR, more preferably from 20 to 30 PHR of carbon black, preferably of carbon black selected from grade N375, grade N220, grade N234 or grade N134 carbon black or mixtures thereof, as determined according to ASTM D1765-18.

Preferably, the rubber composition comprises one or more of the features defined in the present invention.

More particularly, the plasticizer comprising the petroleum-based oil and the vegetable oil defined in the present invention can be used alone, in particular without a phenol or a melamine resin, in order to plasticize the rubber compositions specifically designed for tire and moreover for tire tread application, more particularly with the precise purpose to improve the viscoelastic properties of the rubber composition,

### Rubber Composition of the Invention

The rubber composition of the invention comprises at least one rubber polymer and at least one plasticizer comprising at least one petroleum-based oil and at least one vegetable oil, as detailed above. The rubber composition of the invention comprises at least one rubber polymer and at least one plasticizer composition.

Typically, the rubber polymer is selected from optionally functionalized styrene-butadiene rubber (SBR), polybutadiene rubber (BR), natural rubber (NR), polyisoprene rubber (IR), ethylene-propylene-diene monomer rubber (EPDM), polybutadiene (PB), nitrile butadiene rubber (NBR), polychloroprene rubber, butyl rubber, silicone rubber, and mixtures thereof.

According to an embodiment, the rubber polymer is selected from optionally functionalized styrene-butadiene rubber (SBR), polybutadiene rubber (BR), natural rubber (NR), polyisoprene rubber (IR) and mixtures thereof.

According to an embodiment, the styrene-butadiene rubber (SBR) used in the invention is functionalized.

Preferably, when the styrene-butadiene rubber (SBR) is functionalized, the functional groups may comprise atoms selected from oxygen, nitrogen, phosphorous, sulfur, silicon, and mixture thereof, preferably from oxygen and silicon atoms and mixture thereof.

According to an embodiment, functional groups may be selected from epoxy groups, mono-, di-, tri-alkoxysilane groups, and mixture thereof. Preferably, the functional group of SBR contains one alkoxysilane group and one epoxy group, preferably one trialkoxysilane and one glycidyl group. Among alkoxysilane, mention may be made of methoxysilane and ethoxysilane.

Examples of functional groups may be (3-Glycidyloxypropyl) trimethoxysilane and (3-Glycidyloxypropyl) triethoxysilane.

According to an embodiment, the functionalized SBR comprises randomly distributed styrene and butadiene.

According to an embodiment, the functional groups are groups that are able to react with the silica surface.

Preferably, the functionalized SBR comprises at least one functional group per polymer chain, preferably only one functional group per polymer chain. According to an embodiment, the styrene-butadiene rubber (SBR) is functionalized at the omega chain end only.

The rubbers used in the present invention may be commercially available. The rubber polymer can be in the form of a dry powder, or in the form of granules, or in the form of rubber bloc not oil-extended, or in the form of an oil extended rubber. Typically, in the case of a functionalized styrene-butadiene rubber, the rubber will be in the form of an oil extended rubber.

According to a particular embodiment, the rubber composition of the invention comprises as rubber polymer(s) at least one styrene-butadiene rubber (SBR) and at least one rubber selected from polybutadiene rubber (BR), natural rubber (NR), polyisoprene rubber (IR) and mixtures thereof.

According to a particular embodiment, the rubber polymers further comprise nitrile rubbers and/or butyl rubbers and/or ethylene/propylene/diene polymer (EPDM) and/or neoprene (polychloroprene).

According to another embodiment, the rubber polymers consist in SBR and one or more rubber selected from BR, NR, IR and mixtures thereof. In other word, according to a preferred embodiment, the rubber polymers do not comprise rubber that are different from SBR, BR, NR, or IR.

According to an embodiment, the rubber polymers comprise styrene-butadiene rubber and natural rubber. According to an embodiment, the rubber polymers comprise styrene-butadiene rubber (SBR) and polybutadiene rubber (BR).

According to an embodiment, the rubber polymers comprise styrene-butadiene rubber (SBR), polybutadiene rubber (BR) and natural rubber (NR).

According to an embodiment, the rubber polymers comprise at least 20% by weight, preferably at least 30% by weight, more preferably at least 40% by weight of styrene-butadiene rubber, based on the total weight of the rubber polymers.

According to an embodiment, the rubber polymers comprise:
from 20 to 90% by weight of optionally functionalized styrene-butadiene rubber(s) and
from 10 to 80% by weight of at least one rubber selected from polybutadiene rubber (BR), natural rubber (NR), polyisoprene rubber (IR) and mixtures thereof,

based on the total weight of the rubber polymers.

According to an embodiment, the rubber polymers consist in:
from 20 to 90% by weight of optionally functionalized styrene-butadiene rubber(s) and
from 10 to 80% by weight of one or more rubbers selected from polybutadiene rubber (BR), natural rubber (NR), polyisoprene rubber (IR) and mixtures thereof,
from 0 to 30% by weight of one or more other rubbers selected from butyl rubber, nitrile rubber, EPDM, neoprene, and mixture thereof,

based on the total weight of the rubber polymers.

According to an embodiment, the rubber polymers consist in:
from 20 to 90% by weight of optionally functionalized styrene-butadiene rubber(s) and
from 10 to 80% by weight of one or more rubbers selected from polybutadiene rubber (BR), natural rubber (NR), polyisoprene rubber (IR) and mixtures thereof,

based on the total weight of the rubber polymers.

According to an embodiment, the rubber polymer(s) comprise:
from 30 to 95% by weight, preferably from 40 to 90% by weight, more preferably from 45 to 85% by weight of optionally functionalized styrene-butadiene rubber (SBR);
from 5 to 70% by weight, preferably from 10 to 60% by weight, more preferably from 15 to 55% by weight of natural rubber (NR),

based on the total weight of the rubber polymers.

According to an embodiment, the rubber polymer(s) comprise:
from 20 to 90% by weight, preferably from 30 to 80% by weight, more preferably from 40 to 70% by weight of optionally functionalized styrene-butadiene rubber (SBR);
from 10 to 80% by weight, preferably from 20 to 70% by weight, more preferably from 30 to 60% by weight of polybutadiene rubber (BR),

based on the total weight of the rubber polymers.

According to an embodiment, the rubber polymer(s) comprise:
from 20 to 85% by weight, preferably from 30 to 75% by weight, more preferably from 40 to 65% by weight of optionally functionalized styrene-butadiene rubber (SBR);
from 10 to 80% by weight, preferably from 20 to 70% by weight, more preferably from 30 to 60% by weight of polybutadiene rubber (BR),
from 5 to 70% by weight, preferably from 10 to 50% by weight, more preferably from 15 to 30% by weight of natural rubber (NR),

based on the total weight of the rubber polymers.

According to an embodiment, the rubber polymer(s) comprise:
from 30 to 95% by weight, preferably from 40 to 90% by weight, more preferably from 45 to 85% by weight of styrene-butadiene rubber (SBR);
from 5 to 70% by weight, preferably from 10 to 60% by weight, more preferably from 15 to 55% by weight of natural rubber (NR),

based on the total weight of the rubber polymers.

According to an embodiment, the rubber polymer(s) comprise:
from 20 to 90% by weight, preferably from 30 to 80% by weight, more preferably from 40 to 70% by weight of styrene-butadiene rubber (SBR);
from 10 to 80% by weight, preferably from 20 to 70% by weight, more preferably from 30 to 60% by weight of polybutadiene rubber (BR),

based on the total weight of the rubber polymers.

According to an embodiment, the rubber polymer(s) comprise:
from 20 to 85% by weight, preferably from 30 to 75% by weight, more preferably from 40 to 65% by weight of styrene-butadiene rubber (SBR);
from 10 to 80% by weight, preferably from 20 to 70% by weight, more preferably from 30 to 60% by weight of polybutadiene rubber (BR),
from 5 to 70% by weight, preferably from 10 to 50% by weight, more preferably from 15 to 30% by weight of natural rubber (NR),

based on the total weight of the rubber polymers.

According to a preferred embodiment, the rubber polymers comprise less than 20% by weight of ethylene/propylene/diene polymer (EPDM), preferably less than 20% wt, more preferably less than 10% wt, even more preferably less than 5% wt, ideally less than 1% wt, of ethylene/propylene/diene polymer (EPDM), based on the total weight of the rubber polymers. According to an embodiment, the rubber polymers do not comprise EPDM.

According to a preferred embodiment, the rubber polymers comprise less than 20% by weight of neoprene (polychloroprene), preferably less than 20% wt, more preferably less than 10% wt, even more preferably less than 5% wt, ideally less than 1% wt, of neoprene, based on the total weight of the rubber polymers. According to an embodiment, the rubber polymers do not comprise neoprene.

Preferably, the rubber composition comprises from 10 to 90% wt of rubber polymer(s), preferably from 20 to 75% wt of rubber polymer(s), more preferably from 30 to 60% wt of rubber polymer(s), based on the total weight of the rubber composition.

According to a particular embodiment, the polybutadiene rubber is a cis-1,4-polybutadiene rubber, more particularly a high cis-1,4-polybutadiene rubber obtained with neodymium-based catalyst (Nd-BR).

According to a particular embodiment, the styrene-butadiene rubber polymer is Europrene R72613/Versalis.

According to a particular embodiment, the polybutadiene rubber Nd-BR is Europrene BR40/Versalis.

According to a particular embodiment, the natural rubber NR is cis-1,4-polyisoprene SIR-10—Standard Indonesian Rubber grade 10.

According to a particular embodiment, the polyisoprene rubber is a synthetic polyisoprene rubber, preferably a synthetic cis-1,4-polyisoprene rubber.

Typically, the rubber composition is based on a blend of one or more rubber polymers, generally in the form of a solution, filled with a blend of silica and carbon black.

According to a particular embodiment, the silica is a high dispersion type Ultrasil 7000 from Evonik.

According to an embodiment, the rubber composition comprises from 10 to 90 PHR of silica, preferably from 40 to 80 PHR of silica, more preferably from 50 to 75 PHR of silica.

Typically, the carbon black may a standard carbon black, for example grade N375, grade N220, grade N234 or grade N134 carbon black or mixtures thereof, as determined according to ASTM D1765-18.

Preferably, if carbon black of grade N330, N326, N550 and/or N762 are present in the rubber composition of the invention, they are present in a combined (i.e. total) amount of less than 30 PHR, preferably less than 20 PHR, more preferably less than 10 PHR, even more preferably less than 5 PHR. The grade being determined according to ASTM D1765-18.

According to an embodiment, the rubber composition comprises from 5 to 50 PHR, preferably from 10 to 40 PHR, more preferably from 20 to 30 PHR of carbon black, preferably of carbon black selected from grade N375, grade N220, grade N234 or grade N134 carbon black or mixtures thereof, as determined according to ASTM D1765-18.

According to an embodiment of the invention, the rubber composition comprises:
rubber polymers as defined in the present invention,
from 5 to 80 PHR of the plasticizer composition defined in the present invention, preferably from 20 to 60 PHR, more preferably from 30 to 44 of the plasticizer composition as defined above,
from 5 to 50 PHR, preferably from 10 to 40 PHR, more preferably from 20 to 30 PHR of carbon black, preferably of carbon black selected from grade N375, grade N220, grade N234 or grade N134 carbon black or mixtures thereof, and
from 10 to 90 PHR of silica, preferably from 40 to 80 PHR of silica, more preferably from 50 to 75 PHR of silica.

Other ingredients of standard grades for the rubber industry are coupling agents, e.g. silane coupling agent, zinc oxide, stearic acid, paraffin wax, antiozonant/antioxidant, accelerator, secondary accelerator and crosslinker, e.g. sulphur crosslinker.

One example of silane coupling agent is Si-69 type. One example of antiozonant/antioxidant is N-(1,3-dimethylbutyl)-N′-phenyl-1,4-phenylenediamine (6PPD). One example of accelerator is N-cyclohexyl-2-benzothiazolesulfenamide (CBS). One example of secondary accelerator is diphenylguanidine (DPG).

A typical rubber composition of the invention comprises from 5 to 80 PHR, preferably from 20 to 60 PHR, from 30 to 44 PHR, preferably from 34 to 40 PHR, more preferably about 37 PHR of plasticizer(s) as detailed above.

According to a preferred embodiment, the rubber composition of the invention comprises from 20 to 90 PHR, preferably from 40 to 80 PHR, preferably from 60 to 70 PHR, preferably from 63 to 67 PHR, more preferably about 65 PHR of filler(s).

The rubber composition of the invention can be used in tires including passenger cars tires (PSR or PCR) and truck/bus tires (TBR).

According to a preferred embodiment, the rubber composition of the invention can be used in passenger cars tires and in particular in passenger cars tire treads.

Tires and tire treads can be prepared according to well known method for the skilled person, starting from the rubber composition of the invention.

### EXAMPLES

### Example 1: Preparation of the Plasticizers

Table 1 summarizes the plasticizers that have been prepared and compared. The proportions are indicated in percentage by weight with respect to the total weight of the plasticizer.

TABLE 1

| | CC1 | CC2 | CC3 | CI1 | CI2 | CI3 | CI4 |
|---|---|---|---|---|---|---|---|
| Plaxolene TD | 100% | | | 70% | 70% | | |
| 346 (T-DAE) | | | | | | | |
| Plaxolene MS | | 100% | | | | 70% | 70% |
| 132 (MES) | | | | | | | |
| Epoxidized | | | | 30% | | 30% | |
| soybean oil | | | | | | | |
| Pitch tall oil | | | 100% | | 30% | | 30% |

Table 1bis below shows the physical properties of the epoxidized Soybean Oil that has been tested.

TABLE 1bis

| | |
|---|---|
| Oxirane Content (%) | 6.9% |
| Viscosity at 25° C. (cP) | 400 |
| Specific Gravity | 0.99 |
| APHA Color | 75 |
| EEW 232 Moisture Content (%) | <0.05 |
| Acid Value (mg KOH/g) | 0.2 |
| Iodine Value | 1.5 |

Table 1ter below shows the physical properties of the pitch tall oil that has been tested.

TABLE 1ter

| Property | Specification | Typical Value |
|---|---|---|
| Acid number, mg KOH/g | 100-140 | 100-125 |
| Rosin (%) | | 17-20 |
| TOFA (%) | | 65-70 |
| Unsaponifiables (%) | | 10-15 |
| Moisture (% w/w) | <0.5 | <0.5 |
| Ash (% w/w) | | <0.4 |
| Viscosity at 60° C. (cP) | 200-850 | 300-850 |
| Viscosity at 80° C. (cP) | | 200-300 |
| Pour Point ° C. (° F.) | | 32-38 (90-100) |
| Specific Gravity | | 0.965-0.985 |

### Example 2: Physical Properties of the Plasticizers

Table 2 summarizes all the measured physical properties of the plasticizers defined in the invention in comparison to the properties of the petroleum-based plasticizers T-DAE and MES, taken as references.

TABLE 2
Physical properties of the plasticizers

| | | Cleveland | Kinematic | | Glass | |
|---|---|---|---|---|---|---|
| | Density | Open Cup | viscosity | Aniline | transition | Pour |
| | at 15° C. | Flash Point | 100° C. | Point | temperature | point |
| | ASTM | ASTM | ASTM | ASTM | ASTM | ASTM |
| | D4052 | D92 | D445 | D611 | E1356 | D97 |
| Compositions | (kg/m³) | (° C.) | (mm²/s) | (° C.) | (° C.) | (° C.) |
| CC1 | 948 | 250 | 21 | 69 | −50 | 28 |
| CC2 | 910.5 | 252.1 | 14.7 | 94.5 | −63.3 | −12.5 |
| CI1 | 964 | 272 | 14.5 | 65 | −50 | 21 |
| CI2 | | 247 | 21 | 45 | −44 | 27 |
| CI3 | 928.5 | 268 | 15.6 | 90 | −55 | −12 |
| CI4 | | 248 | 18 | 64 | −58 | −9 |

As can be seen from Table 2, the physical properties of the plasticizers of the invention are similar to or even better than the physical properties of the petroleum-based oil. In particular, the plasticizer compositions of the invention comprising a petroleum-based oil and a vegetable oil have a better aniline point than the petroleum-based oil alone.

### Example 3: Application of the Synthesized Plasticizers in a Tire Tread Composition

The plasticizers reported in Table 1 were tested for their plasticizer properties in a tire tread rubber composition.

A typical passenger car tire tread formulation is shown in Table 3 and is based on a blend of solution styrene-butadiene (S-SBR) rubber dry type (i.e. not oil extended) from Versalis type Europrene sol R72613 with 25% styrene and 64% vinyl without functional groups, a high cis-1,4-polybutadiene obtained with neodymium-based catalyst (Nd-BR) type Europrene BR40 again from Versalis and natural rubber (cis-1,4-polyisoprene) SIR-10 type (Standard Indonesian Rubber grade 10). The selected formulation is filled with a blend of silica and carbon black as shown in Table 3. In particular, the silica was the high dispersion type Ultrasil 7000 from Evonik while carbon black was a standard ASTM grade N375. The other ingredients shown in Table 3 were all standard grades for the rubber industry, i.e. the silane coupling agent was Si-69 type, zinc oxide (ZnO), stearic acid, paraffin wax, antiozonant/antioxidant N-(1,3-dimethylbutyl)-N′-phenyl-1,4-phenylenediamine (6PPD), accelerator N-cyclohexyl-2-benzothiazolesulfenamide (CBS), secondary accelerator diphenylguanidine (DPG) and sulphur crosslinker.

Table 3 below summarizes the tested compositions according to the invention (CI1, CI2, CI3, CI4) and comparative compositions (CC1, CC3).

In the formulation reported in Table 3 the amount of free plasticizer was 34.5 PHR, a level purposely selected to evidence the performances of the new plasticizers in a very critical rubber tread formulation characterized by high filler and moreover high plasticizer loading.

TABLE 3
Rubber tread composition formulation for plasticizers testing

| | R-CC1 | R-CC3 | R-CI1 | R-CI2 | R-CI3 | R-CI4 |
|---|---|---|---|---|---|---|
| Composition ingredients | PHR (parts per 100 by weight of the rubber polymer) | | | | | |
| S-SBR (FX5000 from ARLANXEO) | 52.5 | | | | | |
| Nd-BR (Europrene BR40) | 35.0 | | | | | |
| Natural Rubber (SIR-10) | 15.0 | | | | | |
| Silica (Ultrasil 7000) | 65.0 | | | | | |
| Carbon Black N375 | 22.0 | | | | | |
| T-DAE Plaxolene TD-346 (CC1) | 34.5 | — | — | — | — | — |
| Pitch tail oil (CC3) | — | 34.5 | — | — | — | — |
| CI1 | — | — | 34.5 | — | — | — |
| CI2 | — | — | — | 34.5 | — | — |
| CI3 | — | — | — | — | 34.5 | — |
| CI4 | — | — | — | — | — | 34.5 |

| | |
|---|---|
| Silane Si-69 | 7.0 |
| ZnO | 4.0 |
| Stearic Acid | 2.0 |
| Paraffin Wax | 1.0 |
| 6PPD | 1.5 |
| CBS | 1.8 |
| DPG | 1.8 |
| Sulfur | 1.5 |
| Total | 244.6 |

### Example 4: Preparation of Rubber Compositions

Mixing of each rubber composition was performed in an internal 1.5 L mixer using two successive preparation phases well known to persons skilled in the art: a first phase of thermo-mechanical working or kneading (“nonproductive” phase) at high temperature, up to a maximum temperature of between 110° C. and 190° C., preferably between 130° C. and 180° C., followed by a second phase of mechanical working (“productive” phase) reaching a lower temperature, typically of less than 110° C., for example between 40° C. and 100° C. The crosslinking system is incorporated during the “productive” phase.

### TEST METHODS

Testing of the rubber compositions was performed according to ISO test methods as follows.

Rheometer curves were recorded on an oscillating disc rheometer (ODR) at 175° C. for 8 minutes according the general rules of ISO 6502-2. The elongation at break and tensile strength of rubber cured composition specimens (175° C. for 10 min) were tested according to the ISO 37:2017 test method using dumbbell shaped specimens type 1. The rate of the transverse was 200 mm/min (i.e traction speed).

The DIN abrasion was measured according to ISO 4649:2017 method A and the compression set was measured according to ISO 815 standard.

Table 5 below shows the measured rheometric and mechanical properties. The values are given in comparison to the reference TDAE for which the values are set to 0.

| | methods | R-CC1 | R-CC3 | R-CI2 |
|---|---|---|---|---|
| Rheometer Torque | ISO 3417 | 0 | 13 | 17 |
| (MH-ML) | | | | |
| Tensile strengh | ISO 37: 2017 | 0 | −14 | 8 |
| | specimen type 1 | | | |
| Elongation at break | ISO 37: 2017 | 0 | 1 | 13 |
| | specimen type 1 | | | |
| DIN Abrasion Loss | ISO 4649: 2017 | 0 | −2 | 2 |
| | method A | | | |
| Compression set | ISO 815 | 0 | 7 | −16 |

The results of table 5 show that the composition R-CI2 according to the invention has a better crosslinking than comparative compositions R-CC1 and R-CC3.

The results of table 5 show that the composition R-CI2 according to the invention has a better traction resistance than comparative compositions R-CC1 and R-CC3.

The results of table 5 show that the composition R-CI2 according to the invention has a better tensile strength and thus a better rubber behaviour than comparative compositions R-CC1 and R-CC3.

The results of table 5 show that the composition R-CI2 according to the invention has a lowest compression set than comparative compositions R-CC1 and R-CC3.

The results of table 5 show that the composition R-CI2 according to the invention has an equivalent DIN abrasion loss.

In conclusion of those results, the plasticizer composition as defined in the present invention allows to synergistically improve rheometric and mechanical properties of the rubber composition. Indeed, the rubber composition of the invention has better properties than rubber composition comprising only an aromatic petroleum-based oil or only a vegetable oil.

1.-15. (canceled)

16. A rubber composition for tire applications comprising:
at least one rubber polymer, and
at least one plasticizer comprising at least one vegetable oil and at least one petroleum-based oil selected from T-DAE products, MES products, naphthenic oils, and mixtures thereof.

17. The rubber composition according to claim 16, wherein the rubber polymer is selected from optionally functionalized styrene-butadiene rubber (SBR), polybutadiene rubber (BR), natural rubber (NR), polyisoprene rubber (IR), ethylene-propylene-diene monomer rubber (EPDM), polybutadiene (PB), nitrile butadiene rubber (NBR), polychloroprene rubber, butyl rubber, silicone rubber, and mixtures thereof.

18. The rubber composition according to claim 16, comprising two rubber polymers, wherein the rubber polymers comprises:
from 20 to 90% by weight of styrene-butadiene rubber(s) optionally functionalized and
from 10 to 80% by weight of at least one rubber selected from polybutadiene rubber (BR), natural rubber (NR), polyisoprene rubber (IR) and mixtures thereof,
based on the total weight of the rubber polymers.

19. The rubber composition according to claim 16, wherein the vegetable oil is selected from tall oil, pitch tall oil, optionally epoxidized soybean oil, and mixtures thereof.

20. The rubber composition according to claim 16, wherein the petroleum-based oil is T-DAE and the vegetable oil is pitch tall oil.

21. The rubber composition according to claim 16, wherein the petroleum-based oil is MES and the vegetable oil is an epoxidized soybean oil.

22. The rubber composition according to claim 16, wherein the plasticizer comprises:
from 50 to 99% by weight of petroleum-based oil(s), and
from 1 to 50% by weight of vegetable oil(s), based on the total weight of the plasticizer.

23. The rubber composition according to claim 16, comprising from 5 to 80 PHR of the plasticizer.

24. The rubber composition according to claim 16, further comprising:
from 5 to 50 PHR of carbon black, and
from 10 to 90 PHR of silica.

25. A method to plasticize rubber polymers, the method comprising adding a composition comprising at least one petroleum-derived oil selected from T-DAE products, MES products, naphthenic oils and mixtures thereof, and at least one vegetable oil into rubber polymers.

26. The method according to claim 25, to plasticize a mixture of at least two rubber polymers wherein the rubber polymers comprise from 20 to 90% wt of optionally functionalized styrene-butadiene rubber(s) (SBR) and from 10 to 80% of at least one rubber selected from polybutadiene rubber (BR), natural rubber (NR), polyisoprene rubber (IR) and mixtures thereof, based on the total weight of the rubber polymers.

27. The method according to claim 25, wherein the vegetable oil is selected from tall oil, pitch tall oil, optionally epoxidized soybean oil, and mixtures thereof.

28. The method according to claim 25, wherein (i) the petroleum-based oil is T-DAE and the vegetable oil is pitch tall oil or (ii) the petroleum-based oil is MES and the vegetable oil is an epoxidized soybean oil.

29. A tire tread comprising the rubber composition according to claim 1.

30. A tire comprising a tire tread according to claim 29.

31. The rubber composition according to claim 16, wherein the plasticizer comprises:
from 60 to 90% by weight, of petroleum-based oil(s), and
from 10 to 40% by weight, of vegetable oil(s), based on the total weight of the plasticizer.

32. The rubber composition according to claim 16, comprising from 20 to 60 PHR of the plasticizer.

33. The rubber composition according to claim 16, comprising from 30 to 44 PHR of the plasticizer.

34. The rubber composition according to claim 16, further comprising:
from 10 to 40 PHR of carbon black selected from grade N375, grade N220, grade N234 or grade N134 carbon black or mixtures thereof, and
from 40 to 80 PHR of silica.

35. The rubber composition according to claim 1, further comprising:
from 20 to 30 PHR of carbon black, and
from 50 to 75 PHR of silica.
